(19) United States
(12) Patent Application Publication
(10) Pub. No.: US 2026/0327767 A1
(43) Pub. Date: Oct. 22, 2026

(54) HIGH-STRENGTH HIGH-TOUGHNESS NON-MAGNETIC STAINLESS-STEEL PLATE SUITABLE FOR ULTRA-LOW TEMPERATURE OF -269°C AND ITS MANUFACTURING METHOD

(71) Applicant: Central Iron & Steel Research Institute Company Limited, Beijing (CN)

(72) Inventors: Changjun Wang, Beijing (CN); Jianxiong Liang, Beijing (CN); Mengxing Zhang, Beijing (CN); Yu Liu, Beijing (CN); Shuai Xu, Beijing (CN); Minle Wang, Beijing (CN); Weihan Chu, Beijing (CN); Yongqing Sun, Beijing (CN); Xiaohui Wang, Beijing (CN); Shuai Tian, Beijing (CN); Wenyu Zhao, Beijing (CN); Jiarui Hu, Beijing (CN)

(73) Assignee: Central Iron & Steel Research Institute Company Limited, Beijing (CN)

(21) Appl. No.: 19/387,405

(22) Filed: Nov. 12, 2025

(30) Foreign Application Priority Data
Apr. 16, 2025 (CN) 202510472631.1

(51) Int. Cl. C22C 38/58; C21D 6/00; C21D 8/0221; C21D 9/46; C22C 33/04; C22C 38/00; C22C 38/02; C22C 38/06; C22C 38/42; C22C 38/44; C22C 38/46; C22C 38/48; C22C 38/50; C22C 38/52

(52) U.S. Cl. CPC C22C 38/58; C21D 6/004; C21D 8/0226; C21D 9/46; C22C 33/04; C22C 38/001; C22C 38/004; C22C 38/02; C22C 38/06; C22C 38/42; C22C 38/44; C22C 38/46; C22C 38/48; C22C 38/50; C22C 38/52

(57) ABSTRACT

The present application belongs to the technical field of high-strength stainless-steel and provides a high-strength high-toughness non-magnetic stainless-steel plate suitable for ultra-low temperature of −269° C. and its manufacturing method. The chemical composition of the high-strength high-toughness non-magnetic stainless-steel plate is: C≤0.006%, N: 0.35~0.45%, O≤0.0020%, P≤0.010%, S≤0.005%, Cr: 21.0~22.0%, Ni: 15.0~16.5%, Mo: 2.3~2.6%, Mn: 6.2~10.0%, Si≤0.20%, Nb<0.04%, V: 0.15~0.25%, Cu: 0.10~0.15%, Al≤0.02%, Ti≤0.02%, Co≤0.05%, and the balance is Fe and unavoidable impurities. The present application provides a new stainless-steel with both ultra-high strength, high toughness, complete austenite stability and low magnetic permeability at −269° C.

### CROSS-REFERENCE TO RELATED APPLICATIONS

This application claims priority to Chinese Patent Application No. 202510472631.1, filed on Apr. 16, 2025, which is hereby incorporated by reference in their entirety.

### TECHNICAL FIELD

The present application relates to the technical field of high-strength stainless-steel, and in particular to a high-strength high-toughness non-magnetic stainless-steel plate suitable for ultra-low temperature of −269° C. and its manufacturing method.

### BACKGROUND ART

Ultra-low temperature engineering is crucial to economic development and scientific and technological innovation, wherein, “large-scale nuclear fusion devices” are the most exemplary ultra-low temperature engineering, which are major scientific devices related to energy security. Breakthroughs in ultra-low temperature technology have an irreplaceable supporting role in energy revolution (such as controlled nuclear fusion), cutting-edge scientific devices (such as superconducting accelerators), and deep space exploration (such as spacecraft cryogenic propulsion systems and high-energy particle cooling systems).

With the development of ultra-low temperature technology, traditional austenitic stainless-steel (such as 316LN stainless-steel) is mainly used to prepare engineering equipment because of its good low-temperature stability, but its −269° C. yield strength (~1000 MPa) and anti-sensitization ability can no longer meet the requirements of engineering equipment (such as new generation fusion devices) for material extreme performance, which results in a sharp drop in the reliability of the material under deep low temperature and strong magnetic field environment. With the development of technology, the invention patent with publication number of CN117286426A discloses a high-strength non-magnetic austenitic stainless-steel, which has good non-magnetic properties, the yield strength of 1250~1420 MPa and the tensile strength of 1700~1831 MPa at −269° C.

With the surge in complexity and performance requirements of the engineering equipment in extremely low temperature environments (−269° C.), almost harsh requirements are put forward for structural materials. Existing materials or stainless-steel cannot meet the requirements of ultra-high strength (yield strength ≥1500 MPa and tensile strength ≥1900 MPa at −269° C.), high toughness and non-magnetic properties. Therefore, urgently needing a new type of stainless-steel with both ultra-high strength, high toughness, complete austenite stability and low magnetic permeability at −269° C.

### SUMMARY OF THE INVENTION

In view of the above analysis, the present application aims to provide a high-strength high-toughness non-magnetic stainless-steel plate suitable for ultra-low temperature of −269° C. and its manufacturing method. The stainless-steel plate has higher strength and toughness and lower relative magnetic permeability at −269° C.

On the one hand, the present application provides a high-strength high-toughness non-magnetic stainless-steel plate, by weight percentage, the chemical composition of the stainless-steel plate is: C≤0.006%, N: 0.35~0.45%, 0≤0.0020%, P≤0.010%, S≤0.005%, Cr: 21.0~22.0%, Ni: 15.0~16.5%, Mo: 2.3~2.6%, Mn: 6.2~10.0%, Si≤0.20%, Nb<0.04%, V: 0.15~0.25%, Cu: 0.10~0.15%, Al≤0.02%, Ti≤0.02%, Co≤0.05%, and the balance is Fe and unavoidable impurities.

Furthermore, the chemical composition of the high-strength high-toughness non-magnetic stainless-steel plate is: C≤0.006%, N: 0.37~0.45%, O≤0.0020%, P≤0.010%, S≤0.005%, Cr: 21.0~21.5%, Ni: 15.0~15.4%, Mo: 2.3~2.5%, Mn: 7.0~10.0%, Si≤0.20%, Nb<0.04%, V: 0.15~0.19%, Cu: 0.10~0.15%, Al≤0.02%, Ti: 0.012~0.02%, Co: ≤0.04%, and the balance is Fe and unavoidable impurities.

Furthermore, at ultra-low temperature of −269° C. of liquid helium, the stainless-steel plate has the yield strength of above 1500 MPa, the tensile strength of above 1900 MPa, the elongation after fracture of above 30%, the V-type impact energy of 150~170J, the fracture toughness of 160~200 MPa·m^{1/2}, and the relative magnetic permeability of <1.01.

Furthermore, the grain size of the stainless-steel plate is grade 4-7.

On the other hand, the present application provides a method for manufacturing the high-strength high-toughness non-magnetic stainless-steel plate, and the method comprises the following steps:

S1: Preparing ingredients according to the alloy composition, obtaining the electroslag ingot after performing electric furnace smelting and electroslag remelting.

S2: Performing high temperature diffusion of the electroslag ingot, and then forging to obtain a forging blank.

S3: Rolling the forging blank to obtain a rolled plate.

S4: Finally, performing a solid solution treatment of the rolled plate to obtain a high-strength high-toughness non-magnetic stainless-steel plate.

Furthermore, performing AOD and LF smelting after the electric furnace smelting; the steel pouring temperature is 1480-1520° C.

Furthermore, during the electroslag remelting, the slag system is a ternary slag system of CaF₂—Al₂O₃—CaO, performing remelting under an argon protective atmosphere, and stripping ingot after completing the remelting more than 1h.

Furthermore, the temperature of the high-temperature diffusion is 1190-1210° C., during the forging process, the initial forging temperature is ≥1050° C., and the final forging temperature is ≥900° C.

Furthermore, during the rolling process, the holding temperature before rolling is 1160-1180° C., the initial rolling temperature is ≥1050° C., and the final rolling temperature is ≥900° C.

Furthermore, the holding temperature of the solid solution treatment is 1000-1100° C., the holding time is 30-150 min, and after the solution treatment, rapidly cooling to room temperature by water quenching.

Compared with the prior art, the present application can achieve at least one of the following beneficial effects:
1. Through the design of the alloy composition, the present application controls the C content to be less than 0.006% and the oxygen content to be less than 0.002%; accurately controls the N content to be 0.35%~0.45%; at the same time, it is necessary to strictly control the Mn content to be 6.2%~10.0%, the Nb content to be less than 0.04%, and the Mo content to be 2.3%~2.6%; limiting the Ti and Al element contents, playing a role in solid solution strengthening and grain refinement through the interaction between the elements, and at the same time significantly reducing the contents of high-temperature niobium nitride, titanium nitride and aluminum nitride in stainless-steel, thereby ensuring the strength and the toughness of the stainless-steel plate; at an ultra-low temperature of −269° C. of liquid helium, the yield strength of the stainless-steel plate is above 1500 MPa, the tensile strength is above 1900 MPa, the elongation after fracture is above 30%, the V-type impact energy is 150-170J, the fracture toughness is 160-200 MPa·m^{1/2}, and the relative magnetic permeability is less than 1.01.
2. The present application provides a method for preparing stainless-steel plates based on the compounding of alloy composition, mainly through the processes of smelting in electric furnaces smelting and electroslag remelting, forging, rolling and heat treatment. On the one hand, it can reduce production cost, using the electric furnaces to instead medium-frequency induction furnaces without affecting the performance of the final stainless-steel plates; on the other hand, based on the coordinated regulation of composition-method-organization, through technical means such as high nitrogen interstitial solid solution strengthening, fine grain strengthening and carbon/nitride precipitation strengthening, making the yield strength of the steel of the present application at −269° C. higher than 1500 MPa, and at the same time, the grain structure is uniform, the grains are refined, which makes grain size of the stainless-steel plate reach grade 4-7.
3. The stainless-steel plate produced by the present application has high strength and high toughness, is non-magnetic, and can fully withstand the use at liquid helium temperature of −296° C. Therefore, at liquid helium temperature of −296° C., the stainless-steel plate can be used in strong magnetic field superconducting magnets, structural parts of deep space exploration and ultra-low temperature devices.

In the present application, the above-mentioned technical solutions can also be combined with each other to achieve more preferred combination solutions. Other features and advantages of the present application will be described in the subsequent description, and some advantages can become obvious from the description, or can be understood by practicing the present application. The purpose and other advantages of the present application can be realized and obtained through the contents particularly pointed out in the description and the drawings.

### A BRIEF DESCRIPTION OF DRAWINGS

The accompanying drawings are only used for the purpose of illustrating specific embodiments and are not to be considered as limiting the present application. In the entire drawings, the same reference symbols represent the same components.

FIG. 1 is a microstructure diagram of Embodiment 1;

FIG. 2 is a microstructure diagram of Embodiment 2;

FIG. 3 is a microstructure diagram of Embodiment 4;

FIG. 4 is a grain size diagram of Embodiment 5;

FIG. 5 is a microscopic characterization diagram of the fracture surface after a tensile test at −269° C. of Embodiment 2;

FIG. 6 is an enlarged view of area A in FIG. 5;

FIG. 7 is a microscopic characterization diagram of the fracture surface after a tensile test at −269° C. of Embodiment 3;

FIG. 8 is an enlarged view of area A in FIG. 7;

FIG. 9 is a physical picture of the stainless-steel plate of Embodiment 2.

### DETAILED DESCRIPTION OF THE INVENTION

The preferred embodiments of the present application will be described in detail below in conjunction with the accompanying drawings, wherein the accompanying drawings constitute a part of the present application and are used together with the embodiments of the present application to illustrate the principles of the present application but are not used to limit the scope of the present application.

Ultra-low temperature engineering is crucial to economic development and scientific and technological innovation. With the development of ultra-low temperature technology, mainly using traditional austenitic stainless-steel (such as 316LN stainless-steel) to prepare ultra-low temperature-used engineering equipment or structural parts. The 316LN stainless-steel has good low-temperature stability, but its yield strength at −269° C. is around 1000 MPa. With the surge in complexity and performance requirements of engineering equipment in extremely low temperature environments (−269° C.), almost harsh requirements are put forward for structural materials, and existing materials or stainless-steel cannot meet the requirements of ultra-high strength (yield strength ≥1500 MPa, tensile strength ≥1900 MPa), high toughness and non-magneticity.

Therefore, the present application provides a high-strength high-toughness non-magnetic stainless-steel plate, by weight percentage, whose chemical composition is: C≤0.006%, N: 0.35~0.45%, O≤0.0020%, P≤0.010%, S≤0.005%, Cr: 21.0~22.0%, Ni: 15.0~16.5%, Mo: 2.3~2.6%, Mn: 6.2~10.0%, Si≤0.20%, Nb<0.04%, V: 0.15~0.25%, Cu: 0.10~0.15%, Al≤0.02%, Ti≤0.02%, Co≤0.05%, and the balance is Fe and unavoidable impurities.

Compared with the prior art, through the design of the alloy composition, the present application controls the C content to be less than 0.006% and the oxygen content to be less than 0.002%; accurately controls the N content to be 0.35%~0.45%; at the same time, it is necessary to strictly control the Mn content to be 6.2%~10.0%, the Nb content to be less than 0.04%, and the Mo content to be 2.3%~2.6%; limiting the Ti and Al element contents, playing a role in solid solution strengthening and grain refinement through the interaction between the elements, and at the same time significantly reducing the contents of high-temperature niobium nitride, titanium nitride and aluminum nitride in stainless-steel, thereby ensuring the strength and the toughness of the stainless-steel plate; at an ultra-low temperature of −269° C. of liquid helium, the yield strength of the stainless-steel plate is above 1500 MPa, the tensile strength is above 1900 MPa, the elongation after fracture is above 30%, the V-type impact energy is 150-170J, the fracture toughness is 160-200 MPa·m^{1/2}, and the relative magnetic permeability is less than 1.01.

The role of each element in the present application is as follows:

Carbon: C is an austenite stabilizing element, and its austenite stabilizing effect is more effective than that of Ni according to the Ni_{eq} formula. However, the presence of C element is prone to precipitate carbides Cr₂₃C₆ at the grain boundaries, which causing the matrix near the austenite grain boundaries to be poor in Cr, thereby greatly reducing its intergranular corrosion resistance. In order to avoid the precipitation of M₂₃C₆ carbides and maintain the C content in the steel, a combination of C and N can be used. Therefore, an ultra-low carbon content needs to be controlled in the steel of the present application. Taking all factors into consideration, the carbon content of the steel of the present application is controlled within 0.006%.

Nitrogen: nitrogen is an interstitial alloying element dissolved in the austenite lattice, which can play a role in solid solution strengthening. According to the Ni_{eq} formula, N is a stronger austenite-forming element and austenite stabilizer than Ni. In Cr—Ni steel, N reduces the content of δ-ferrite. Therefore, the nitrogen content is precisely controlled in the range of 0.35-0.45% in the present application.

Chromium: chromium is a ferrite stabilizing element. Increasing the chromium content will promote the formation of high-temperature Cr₂N and medium-temperature M₂₃C₆, which will seriously deteriorate the high-temperature forgeability and low-temperature toughness of the steel. In addition, chromium passivates the steel, so the increase in the chromium content improves the corrosion resistance of the steel. The addition of Cr improves the oxidation resistance of the alloy at higher temperatures, and compared with interstitial alloying elements, Cr also has a moderate solid solution strengthening effect. The addition of Cr can increase the yield strength and tensile strength of the steel. Therefore, the chromium content of the steel of the present application is 21.0~22.0%.

Nickel: nickel is an alloying element for stabilizing austenite, while can also inhibit the formation of high temperature δ ferrite. As more and more nickel is added into 18% Cr ferritic stainless-steel, the structure gradually transforms into austenite. There is a certain relationship between the contents of Ni and Cr required to maintain the austenitic structure. At the level of 18% Cr, if the % Ni is about 8%, the austenitic structure persists at room temperature. When the Cr content is higher or lower, the Ni content must be adjusted to maintain a complete austenitic structure, and vice versa. In addition, nickel can improve the low temperature properties of nickel-chromium based austenitic stainless-steel. Taking all factors into consideration, the nickel content of the steel of the present application is 15.0~16.5%.

Molybdenum: molybdenum is an alloying element that forms ferrite. The addition of Mo can improve the hardness of the alloy, but the effect of Mo is smaller than that of C and N. Mo introduces lattice strain, which increases the tensile strength and yield strength of the alloy. The addition of Mo can also improve the hot strength of the alloy and reduce the hot plasticity of the alloy. Mo also promotes the formation of intermetallic phases, especially the sigma phase that causes room temperature embrittlement. In order to minimize the ferrite content in the cast (austenite) product at room temperature, it must be carefully to control the composition balance during the steelmaking process. Taking all factors into consideration, the molybdenum content of the steel of the present application is 2.3-2.6%.

Manganese: as the core alloying element of high-nitrogen austenitic stainless-steel, manganese achieves efficient solid solution and structural stability of nitrogen through a dual mechanism: first, its unique electronic layer structure can form a strong binding force with nitrogen atoms, which significantly improves the solubility of nitrogen in the austenite matrix during the process of high-temperature smelting, and makes manganese become a key carrier in the design of high-nitrogen steel; at the same time, as a strong austenite-forming element, it expands the γ phase region to make the high-nitrogen austenite structure remain metastable state at room temperature, which effectively inhibits high-temperature δ ferrite, thereby reducing the magnetic permeability.

In terms of process, the addition of manganese reduces the critical cooling rate to the range that can be operated by conventional quenching, which ensures thick-section components obtain a fully austenitic structure, and the substitution effect of manganese for nickel significantly reduces material costs while maintaining phase stability. Based on the above synergistic effect, in order to ensure the best balance between high nitrogen solid solution strengthening effect and processing performance, the manganese content of the steel of the present application is 6.2-10.0%.

Silicon: Si is a ferrite-forming element, can improve the corrosion resistance of steel, and plays a deoxidizing role in the alloy smelting process. The element Si generally reduces the mechanical properties of the alloy and increases the tendency of welding hot cracking. Excessive addition of element Si will increase the probability of ferrite precipitation in the alloy and induce the precipitation of chromium carbide at the grain boundaries, which will deplete the Cr element at the grain boundaries and deteriorate the mechanical and corrosion resistance of the alloy, therefore, the silicon content needs to be strictly controlled. Considering the above, the silicon content in the steel of the present application is controlled within 0.2%.

Phosphorus and sulfur: P and S are impurity elements in steel. P can significantly reduce the corrosion resistance of chromium-nickel stainless-steel to various concentrations of nitric acid in the solid solution state and sensitized state. S can reduce the thermoplasticity of stainless-steel, affect the hot workability of steel, and also reduce the corrosion resistance of stainless-steel. Since the steel of the present application adopts the low-cost electric furnace+electroslag remelting double ultra-pure smelting process and uses pure metal materials for smelting, the phosphorus and sulfur contents are controlled within 0.010% and 0.005% respectively.

Oxygen: O is a harmful element in steel. O element mainly exists in the form of various inclusions, which seriously reduces the processing performance, plasticity and fatigue performance of steel. Taking all factors into consideration, the oxygen content in the steel of the present application is controlled within 0.0020% (20 ppm).

Vanadium: a small amount of V can play a role in refining the grains, which improves the strength and toughness of the steel. However, excessive V will form V(C,N) with C and N, which reduces the low-temperature toughness of the steel. Taking all factors into consideration, the vanadium content in the steel of the present application is 0.15~0.25%.

Niobium: the addition of Nb in the stainless-steel can prevent intergranular corrosion. Nb can refine grains and reduce the overheat sensitivity and temper brittleness of steel, and improve strength, but reduce plasticity and toughness. Taking all factors into consideration, the niobium content in the steel of the present application is controlled to be less than 0.04%.

Copper: copper is a common stainless-steel alloy element and has a wide range of uses. In austenitic stainless-steel, the addition of copper can improve its strength and corrosion resistance, but also reduces its oxidation resistance. Therefore, the copper content in the steel of the present application is 0.10-0.15%.

Aluminum: Al is a common deoxidizer used in steel. A small amount addition of Al in steel can refine the grains and improve impact toughness. Aluminum also has antioxidant performance and corrosion resistance, which can significantly improve the high-temperature non-scaling performance and high-temperature corrosion resistance of steel by combining Al with Cr and Si. However, Al will form high-temperature AlN, which will damage the plastic toughness and hot working properties of steel. Therefore, the aluminum content in the steel of the present application must be strictly controlled within 0.02%.

Titanium: The addition of Ti can refine austenite grains and indirectly improve the strength and toughness of the material. However, excessive Ti will combine with N or C in the steel to form hard and brittle TiN or TiC inclusions. Therefore, the titanium content in the steel of the present application must be strictly controlled within 0.02%.

Cobalt: Co is an austenite stabilizing element. It can improve the high temperature strength and creep resistance of the material when dissolved in the matrix. In the nuclear industry, Co may be used to regulate the irradiation performance of the material, but attention should be paid to its activation problem. Excessive Co may interfere with the stability of austenite, promote the precipitation of brittle intermetallic phases (such as o phase), and cause the embrittlement of the material at high temperatures. Therefore, the cobalt content in the steel of the present application must be strictly controlled within 0.05%.

Specifically, by weight percentages, the chemical composition of the high-strength high-toughness non-magnetic stainless-steel plate is: C≤0.006%, N: 0.37~0.45%, O≤0.0020%, P≤0.010%, S≤0.005%, Cr: 21.0~21.5%, Ni: 15.0~15.4%, Mo: 2.3~2.5%, Mn: 7.0~10.0%, Si≤0.20%, Nb<0.04%, V: 0.15~0.19%, Cu: 0.10~0.15%, Al≤0.02%, Ti: 0.012~0.02%, Co: ≤0.04%, and the balance is Fe and unavoidable impurities.

The present application provides a method for manufacturing the high-strength high-toughness non-magnetic stainless-steel plate, and the method comprises the following steps:

S1: preparing ingredients according to the alloy composition, obtaining the electroslag ingot after performing electric furnace smelting and electroslag remelting.

S2: performing high temperature diffusion of the electroslag ingot, and then forging to obtain a forging blank.

S3: rolling the obtained forging blank to obtain a rolled plate.

S4: finally, performing a solid solution treatment of the obtained rolled plate to obtain a high-strength high-toughness non-magnetic stainless-steel plate.

Compared with existing technology, the present application provides a method for preparing stainless-steel plates based on the compounding of alloy composition, mainly through the processes of smelting in electric furnaces and electroslag remelting, forging, rolling and heat treatment. On the one hand, it can reduce production cost, using the electric furnaces to instead medium-frequency induction furnaces without affecting the performance of the final stainless-steel plates; on the other hand, based on the coordinated regulation of composition-method-organization, through technical means such as high nitrogen interstitial solid solution strengthening, fine grain strengthening and carbon/nitride precipitation strengthening, making the yield strength of the steel of the present application at −269° C. higher than 1500 MPa, and at the same time, the grain structure is uniform, the grains are refined, which makes grain size of the stainless-steel plate reach grade 4-7.

Specifically, in the step S1, performing AOD and LF smelting after the electric furnace smelting; the steel pouring temperature is 1480-1520° C.

Specifically, during the electroslag remelting, the slag system is a ternary slag system of CaF₂—Al₂O₃—CaO, performing remelting under an argon protective atmosphere, and stripping ingot after completing the remelting more than 1h.

It should be noted that, the present application adopts 40t electric furnace+AOD+LF smelting, blowing oxygen, argon for decarburization, and blowing nitrogen to increase nitrogen in the AOD refining process. Al deoxidation is used in the LF refining stage to fine-tune the alloy and ensure each element reach the target composition.

The preferred process of the electroslag remelting includes: using a die-cast electrode rod (i.e. obtaining a steel ingot after smelting in an electric furnace+AOD+LF) as a consumable electrode for electroslag remelting, the slag system is a ternary slag system of CaF₂—Al₂O₃—CaO, remelting under an argon protective atmosphere, and stripping ingot after completing the remelting for >1h.

In the present application, the weight ratio of CaF₂, Al₂O₃, and CaO in the ternary slag system of CaF₂—Al₂O₃—CaO is 70:15:15.

Specifically, the temperature of the high-temperature diffusion is 1190-1210° C., during the forging process, the initial forging temperature is ≥1050° C., and the final forging temperature is ≥900° C.

Specifically, the forging ratio is greater than 6.

It should be noted that, in the present application, elements Cr and N can form a Cr₂N brittle phase, so performing high-temperature diffusion at 1190-1210° C. before forging to completely dissolve the Cr₂N brittle phase. The high-temperature diffusion at the temperature range also makes the Nb element be diffused more evenly, thereby ensuring the strength and toughness of the final stainless-steel plate.

In the present application, the temperature of the high temperature diffusion may be 1190° C., 1195° C., 1200° C., 1205° C. or 1210° C.

In the present application, adopting a forging method of one upsetting and one drawing in the forging process, and controlling the forging ratio to be greater than 6, and making the electroslag ingot with a specification of φ770 be deformed into a forging blank with a thickness of 8100-180 mm.

Specifically, during the rolling process, the holding temperature before rolling is 1160-1180° C., the initial rolling temperature is ≥1050° C., and the final rolling temperature is ≥900° C.

Specifically, the rolling ratio is not less than 2.

It should be noted that, in the present application, controlling the holding temperature before rolling at 1160-1180° C., controlling the rolling ratio to be not less than 2, making the forging blank with a thickness of 8100-180 mm deform to the plate with a thickness of 84-90 mm, while the grain size can be controlled to avoid excessive coarse grains. Appropriate rolling temperature is conducive to the diffusion of alloy elements, thereby obtaining a more uniform structure. The holding temperature before rolling of the present application can be 1160° C., 1167° C., 1170° C., 1175° C. or 1180° C.

Specifically, the holding temperature of the solid solution treatment is 1000-1100° C., the holding time is 30-150 min, and after the solution treatment, rapidly cooling to room temperature by water quenching.

It should be noted that, in the present application, a solid solution treatment is required after rolling with temperature controlled to be 1000-1100° C., and can be 1000° C., 1010° C., 1020° C., 1030° C., 1030° C., 1050° C., 1060° C., 1070° C., 1080° C., 1090° C. or 1100° C., preferably 1050-1070° C.

In the present application, when the solid solution temperature exceeds 1100° C., the grains grow abnormally and become coarser, which can reduce the strength and toughness of the stainless-steel plate; when the solution temperature is lower than 1000° C., the precipitated phase cannot be dissolved back, which will also affect the performance of the stainless-steel plate.

Specifically, the stainless-steel plate provided by the present application is used in the structural parts of strong-magnetic field superconducting magnets, deep space exploration and ultra-low temperature devices at a liquid helium temperature of −296° C.

It should be noted that, the stainless-steel plate produced by the present application has high strength and high toughness. At the ultra-low temperature of −269° C. of liquid helium, the yield strength of the stainless-steel plate is above 1500 MPa, the tensile strength is above 1900 MPa, the elongation after fracture is above 30%, the V-type impact energy is 150~170 J, the fracture toughness is 160~200 MPa·m^{1/2}, and the relative magnetic permeability is less than 1.01, which can fully withstand the use of −296° C. liquid helium temperature. Therefore, it can be used in strong magnetic field superconducting magnets, deep space exploration and ultra-low temperature device structural parts at −296° C. liquid helium temperature.

In order to more clearly describe the present application, it is further illustrated by the following embodiments and comparative embodiments

### Embodiment 1

A method for manufacturing a stainless-steel comprises the following steps:

S1: preparing ingredients according to the alloy composition, obtaining the electroslag ingot after performing electric furnace smelting and electroslag remelting.

Wherein, the smelting adopts 40t electric furnace, AOD and LF smelting.

Wherein, in the electroslag remelting, the slag system is a ternary slag system of CaF₂—Al₂O₃—CaO with weight percentages of 70%, 15%, 15% respectively.

S2: performing high temperature diffusion of the φ770 mm electroslag ingot, and then forging to obtain a forging blank of 150 mm×630 mm×L, wherein, the forging ratio is 8.

The temperature of the high-temperature diffusion is 1210° C., during the forging process, the initial forging temperature is 1110° C., and the final forging temperature is 940° C.

S3: rolling the obtained forging blank to obtain a rolled plate of thickness 875 mm×width 630 mm×L, wherein, the rolling ratio is 2.

During the rolling process, the holding temperature before rolling is 1170° C., the initial rolling temperature is 1060° C., and the final rolling temperature is 900° C.

S4: finally, performing a solid solution treatment of the obtained rolled plate, the holding temperature of the solid solution treatment is 1050° C., the holding time is 120 min, and after the solution treatment, rapidly cooling to room temperature by water quenching to obtain a high-strength high-toughness non-magnetic stainless-steel plate.

The chemical composition of the plate material of Embodiment 1 is shown in Table 1.

### Embodiments 2-5

The chemical compositions and preparation processes of Embodiments 2-5 are substantially the same as those of Embodiment 1, and the differences are shown in Tables 1 and Table 2.

TABLE 1
the chemical compositions (wt %) of Embodiments 1-5

| | C | N | O | P | S | Cr | Ni | Mo |
|---|---|---|---|---|---|---|---|---|
| Design value | ≤0.006 | 0.35-0.45 | ≤0.0020 | ≤0.01 | ≤0.005 | 21.0-22.0 | 15.0-16.5 | 2.3-2.6 |
| Embodiment 1 | 0.0025 | 0.43 | 0.0019 | 0.005 | 0.0008 | 21.46 | 15.25 | 2.43 |
| Embodiment 2 | 0.0027 | 0.37 | 0.0013 | 0.005 | 0.0005 | 21.39 | 15.32 | 2.41 |
| Embodiment 3 | 0.0032 | 0.41 | 0.0014 | 0.007 | 0.0004 | 21.4 | 15.23 | 2.32 |
| Embodiment 4 | 0.0053 | 0.39 | 0.0012 | 0.006 | 0.0008 | 21.31 | 15.04 | 2.46 |
| Embodiment 5 | 0.005 | 0.40 | 0.0013 | 0.008 | 0.0007 | 21.37 | 15.4 | 2.37 |

| | Mn | Si | Nb | V | Cu | Al | Ti | Co |
|---|---|---|---|---|---|---|---|---|
| Design value | 6.2-10.0 | ≤0.2 | <0.04 | 0.15-0.25 | 0.10-0.15 | ≤0.02 | ≤0.02 | ≤0.05 |
| Embodiment 1 | 9.53 | 0.09 | 0.033 | 0.17 | 0.14 | 0.02 | 0.018 | 0.04 |
| Embodiment 2 | 6.89 | 0.08 | 0.039 | 0.18 | 0.15 | 0.02 | 0.015 | 0.04 |
| Embodiment 3 | 8.94 | 0.03 | 0.025 | 0.19 | 0.13 | 0.019 | 0.016 | 0.02 |
| Embodiment 4 | 7.02 | 0.05 | 0.035 | 0.19 | 0.12 | 0.017 | 0.012 | 0.03 |
| Embodiment 5 | 7.99 | 0.07 | 0.038 | 0.16 | 0.14 | 0.018 | 0.016 | 0.02 |

TABLE 2
preparation parameters of Embodiments 1-5

| | High-temperature | Initial forging | Final forging | Initial rolling | Final rolling | Solid solution |
|---|---|---|---|---|---|---|
| | diffusion | temperature | temperature | temperature | temperature | temperature |
| Group | temperature (°C) | (°C) | (°C) | (°C) | (°C) | (°C) |
| Embodiment 1 | 1210 | 1110 | 940 | 1060 | 900 | 1050 |
| Embodiment 2 | 1200 | 1100 | 930 | 1070 | 920 | 1070 |
| Embodiment 3 | 1200 | 1120 | 950 | 1070 | 950 | 1060 |
| Embodiment 4 | 1190 | 1109 | 920 | 1050 | 960 | 1070 |
| Embodiment 5 | 1200 | 1100 | 935 | 1050 | 980 | 1070 |

### Comparative Embodiment 1

Comparative Embodiment 1 adopts the preparation method and composition ratio of Embodiment 1 in the invention patent with publication number of CN117286426A, and the details are as follows:

The chemical composition is: C: 0.0058%, N: 0.27%, O: 0.0013%, P: 0.0046%, S: 0.0036%, Cr: 21.67%, Ni: 14.47%, Mo: 1.92%, Mn: 6.0%, Si: 0.13%, Nb: 0.07%, V: 0.13%, Cu: 0.15%, Al: 0.008%, H: 0.00057%.

The preparation method is:

Smelting: medium frequency induction furnace and electroslag remelting, wherein, the electroslag remelting slag system is quaternary slag system of CaF₂—Al₂O₃—CaO—MgO.

Forging: performing high temperature diffusion at temperature of 1210° C. before forging; the initial forging temperature is 1070° C.; the final forging temperature is 890° C.

Heat treatment process: performing solid solution at temperature of 1120° cand holding for 2h.

### Comparative Embodiment 2

The preparation process of Comparative Embodiment 2 is substantially the same as that of Embodiment 1, except that the material used in Comparative Embodiment 2 is 316LN.

### Comparative Embodiment 3

The preparation process of Comparative Embodiment 3 is substantially the same as that of Embodiment 1, except that in Comparative Embodiment 3, the N content is 0.27% and the Mn content is 5.5%.

### Comparative Embodiment 4

The preparation process of Comparative Embodiment 4 is substantially the same as that of Embodiment 1, except that in Comparative Embodiment 4, the Ti content is 0.05% and the Co content is 0.08%.

### Comparative Embodiment 5

The preparation process of Comparative Embodiment 5 is substantially the same as that of Embodiment 1, except that the solid solution temperature is 1170° C. in Comparative Embodiment 5.

### Performance Testing

Performing performance tests of the above-mentioned Embodiments 1-5 and Comparative Embodiments 1-5, mainly including yield strength, tensile strength, impact toughness, elongation after fracture, and fracture toughness. The test temperature is −269° C., and the test results are shown in Table 3.

TABLE 3
performance test results

| | | | Elongation | | |
|---|---|---|---|---|---|
| | Tensile | Yield | after | Impact | Fracture |
| | strength | strength | fracture | energy | toughness (K_{IC}, |
| Group | (MPa) | (MPa) | (%) | (J) | MPa · m^{1/2}) |
| Embodiment | 1983 | 1693 | 34 | 161 | 187 |
| 1 | | | | | |
| Embodiment | 1920 | 1514 | 38 | 155 | 162 |
| 2 | | | | | |
| Embodiment | 1975 | 1676 | 33 | 153 | 173 |
| 3 | | | | | |
| Embodiment | 1943 | 1555 | 38 | 162 | 193 |
| 4 | | | | | |
| Embodiment | 1935 | 1544 | 40 | 169 | 167 |
| 5 | | | | | |
| Comparative | 1771 | 1420 | 28.5 | 105 | 155 |
| embodiment 1 | | | | | |
| Comparative | 1478 | 980 | 30 | 157 | 190 |
| embodiment 2 | | | | | |
| Comparative | 1778 | 1404 | 33.5 | 109 | 153 |
| embodiment 3 | | | | | |
| Comparative | 1760 | 1450 | 25 | 90 | 130 |
| embodiment 4 | | | | | |
| Comparative | 1712 | 1155 | 40.5 | 184 | 179 |
| embodiment 5 | | | | | |

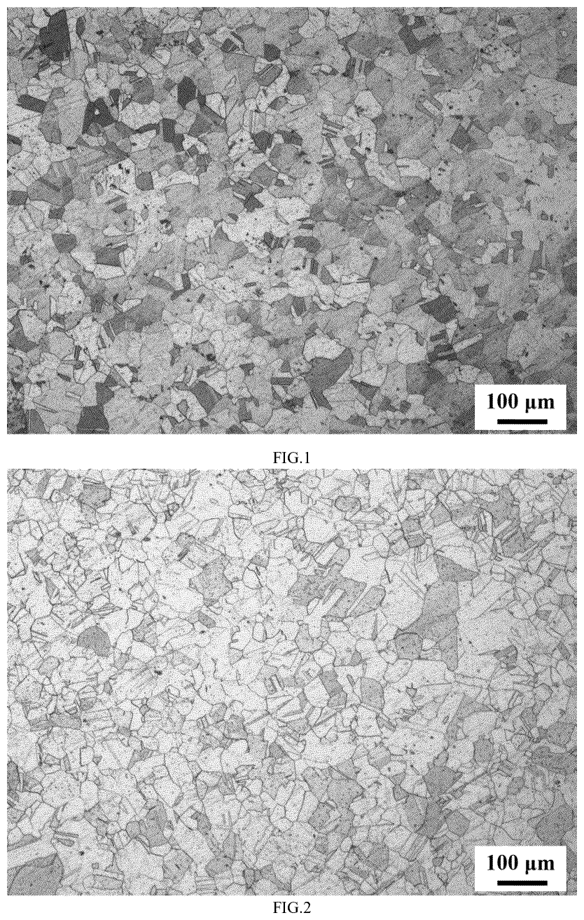

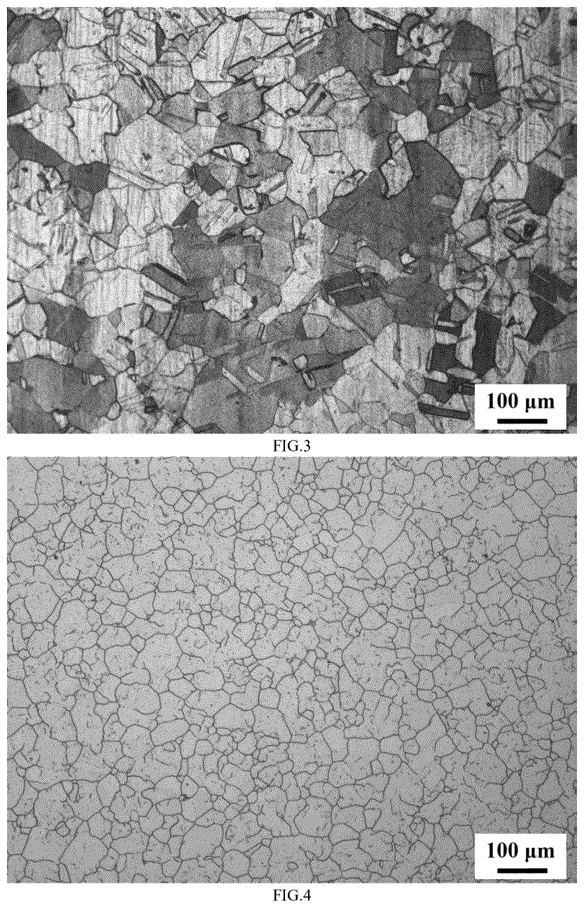

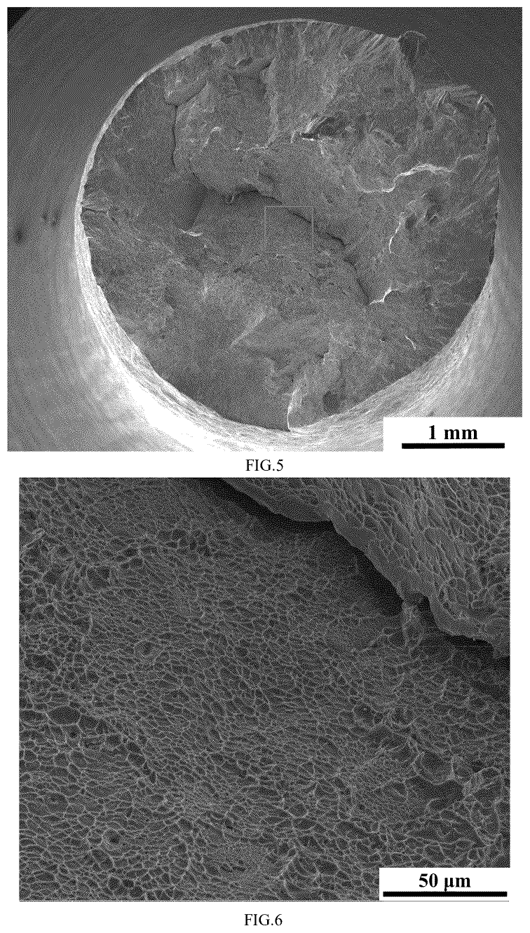

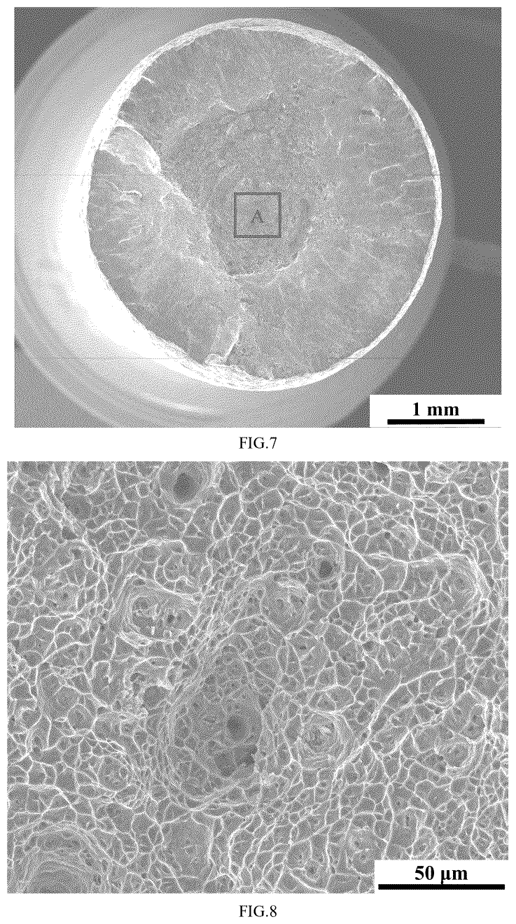

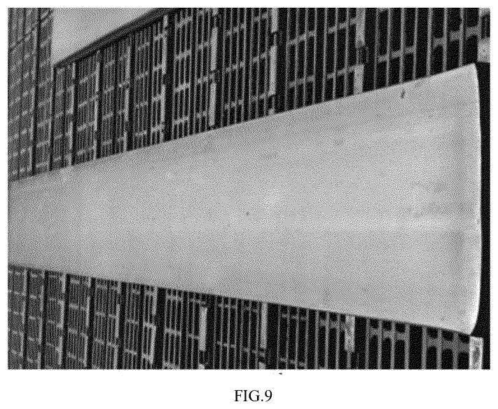

From the combination of Examples 1-5 and Comparative Examples 1-5 and by referring to FIGS. 1 to 9, it can be seen that, by using the composition ratios and manufacturing methods of Embodiments 1-5 of the present application, the yield strength of the obtained stainless-steel plate is 1514-1693 MPa, the tensile strength is 1920-1983 MPa, the elongation after fracture is 33-40%, the V-type impact energy is 153-169J, the fracture toughness K_{IC} is 162-193 MPa·m^{1/2}, and the relative magnetic permeability is <1.01.

In addition, by observing the microstructure diagram and the fracture microscopic characterization diagram, it can be seen that the grain size of the steel plate of the present application is uniform, the size distribution is uniform, and the grain size can reach grade 4-7. The microstructure is an austenite matrix without M₂₃C₆ type carbides and δ-ferrite. After the −269° C. tensile test, many dimples are present in the cross-section structure, which indicates that the steel of the present application has a ductile fracture.

The above described are only preferred embodiments of the present application. but the protection scope of the present application is not limited thereto. Any changes or substitutions that can be easily conceived by any technician familiar with the technical field within the technical scope disclosed by the present application should be covered within the protection scope of the present application

1. A high-strength high-toughness non-magnetic stainless-steel plate, by weight percentage, a chemical composition of the high-strength high-toughness non-magnetic stainless-steel plate is: C≤0.006%, N: 0.35~0.45%, O≤0.0020%, P≤0.010%, S≤0.005%, Cr: 21.0~22.0%, Ni: 15.0~16.5%, Mo: 2.3~2.6%, Mn: 6.2~10.0%, Si≤0.20%, Nb<0.04%, V: 0.15~0.25%, Cu: 0.10~0.15%, Al≤0.02%, Ti≤0.02%, Co≤0.05%, and the balance is Fe and unavoidable impurities;
wherein at an ultra-low temperature of −269° C. of liquid helium, a yield strength of the stainless-steel plate is above 1500 MPa, a tensile strength is above 1920 MPa, a V-type impact energy is 150-170J, a fracture toughness is 160-200 MPa·m^{1/2};
wherein a grain size of the stainless-steel plate is grade 4-7, without M₂₃C₆ type carbides and δ-ferrite.

2. The high-strength high-toughness non-magnetic stainless-steel plate according to claim 1, wherein, by weight percentage, the chemical composition of the stainless-steel plate is: C≤0.006%, N: 0.37~0.45%, O≤0.0020%, P≤0.010%, S≤0.005%, Cr: 21.0~21.5%, Ni: 15.0~15.4%, Mo: 2.3~2.5%, Mn: 7.0~10.0%, Si≤0.20%, Nb<0.04%, V: 0.15~0.19%, Cu: 0.10~0.15%, Al≤0.02%, Ti: 0.012~0.02%, Co: ≤0.04%, and the balance is Fe and unavoidable impurities.

3. The high-strength high-toughness non-magnetic stainless-steel plate according to claim 1, wherein, at an ultra-low temperature of −269° C. of liquid helium, the stainless-steel plate has a elongation after fracture of above 30%, and a relative magnetic permeability of <1.01.
